(19) United States
(12) Patent Application Publication
(10) Pub. No.: US 2006/0164517 A1
(43) Pub. Date: Jul. 27, 2006

(54) Method for digital recording, storage and/or transmission of information by means of a camera provided on a comunication terminal

(75) Inventor: Martin Lefebure, Courbevoie (FR)

Correspondence Address: BROWDY AND NEIMARK, P.L.L.C.;624 NINTH STREET, NW, SUITE 300, WASHINGTON, DC, 20001-5303, US

(73) Assignee: Real Eyes 3D, Saint Cloud Cedex (FR)

(21) Appl. No.: 10/515,843

(22) PCT Filed: May 27, 2003
(86) PCT No.: PCT/FR03/01606

§ 371 Date: Sep. 1, 2005

(30) Foreign Application Priority Data
May 27, 2002 (FR) 02/06579

(51) Int. Cl. H04N 5/228

(52) U.S. Cl. 348/222.1

(57) ABSTRACT

The invention relates to a method for selection of a digitising zone by a camera (CN), correction of the projection distortion, resolution enhancement, then binarisation, comprising the following operation steps: generation of a closed contour (DC) within the document for processing (O) or around the document for processing (O), produced manually or printed, presentation of the document for processing (O) in front of the camera (CN) at an angle such that said contour is entirely visible within the image present on the visualisation screen (AF), recording the image and searching for the contour within the image, calculation of projection distortions (bloc CC), extraction and fusion of the image contents and generation of the final image.

The present invention relates to a method for digital capture of information present on a medium, by means of a camera fitting out a communications terminal. Its object is to enable the terminal to store and/or transmit this information to an addressee, it being understood that in order for it to be able to be used, this information should be extracted and corrected to notably take projective distortions into account and/or completed by incorporating a background and/or textual data.

It is notably but not exclusively applied to transmitting and storing textual data and digitally scanned graphics, as previewed by a camera under any incidence and then processed with correction of the projective distortion and possibly with enhancement of the resolution.

Such a process is most particularly suitable for transmitting textual and/or graphic information taken by a camera fitting out a portable communications terminal such as a cellular radio transmitter/receiver for example.

Indeed, for this type of applications, when one desires to transmit a written message extracted from a photograph to an addressee, it is frequently required that corrections be made without which the message appearing in the photograph received by the addressee, would be illegible. Also, it turns out to be desirable to proceed with inclusions of external patterns, for example captions inputted on the keyboard of the device, into the transmitted image, or even to perform superimposition of the image taken by the camera and of a background which may for example be selected in a library accessible by the unit.

It is generally known that information has become ubiquitous today and that its control is essential; now this information largely consists of text data.

Knowledge, whether it be technical, scientific, historical, economic, legal, medical knowledge, is mostly stored and conveyed by texts; recently published knowledge is directly accessible in electronic form; on the other hand, the majority of inherited knowledge is still only available in paper document form.

Society is thus confronted with an enormous reprocessing need, also called retroconversion, for changing over to an electronic format.

Document recognition is related to image recognition; it concerns all matters about written language and its digital transformation: character recognition, text formatting, content structuring and accessing information through its indexation.

So it is a matter of rediscovering an existing structure so that the recognition is guided by an explicit or implicit model of the investigated document class. The model describes the items which compose the document and their relationships, this description may be physical such as by giving the page make-up format.

Moreover, it is known that interpretation by a person of a text or a graphic previewed by a camera, assumes a quasi-normal or perpendicular shot relative to the document bearing the text or graphic and sufficient resolution for distinguishing details.

It may easily be understood that the reading of a text by the person receiving the message is largely facilitated under normal or quasi-normal incidence relatively to the plane of the document; as for the interpretation of a graphic, it almost inevitably requires compliance with shapes and proportions.

Finally, character and document recognition has made considerable progress; the scanners provide sufficient resolution for subsequent recognition steps; the latter are the following:
acquisition or digitization,
straightening-up,
quantification,
binarization,
page segmentation,
character recognition,
logical structure recognition.

To enhance the quality of segmentation and automatic character recognition, it is desirable that the image of the document be perfectly straight and with sufficient resolution; this notably facilitates searching for columns of the text, when two consecutive columns are very close to each other, and recognizing characters if the latter are of a particularly reduced size; the global offset angle of the page therefore needs to be detected and the definition of the image needs to be enhanced, notably, of those coming from a camera with insufficient quality for distinguishing the details of a text or a graphic taken at a certain distance and for guaranteeing a minimum resolution for recognizing the characters; several algorithms have been developed for detecting the tilt angle of the text; however, the latter should not exceed 10-20° in the scanning plane.

The difficulty becomes insurmountable when the document has been viewed by a camera under any incidence, as the document has undergone a projective distortion: starting from a certain distance of the camera, it is seen that details in the image which are required for recognizing characters and consequently for understanding the document, disappear.

More specifically, the object of the invention is to abolish these drawbacks and to allow corrected information, possibly completed by inclusion of a background and/or textual data, to be stored and/or transmitted to an addressee.

Of course, to achieve this result, the invention proposes a solution taking into account constraints due to the size of a standard communication terminal, to both hardware and software resources and transmission rates.

Accordingly, the method according to the invention comprises the following steps:
taking at least one image by the camera,
at least partially extracting identifiable contextual data included in said image by processing means integrated into said terminal,
extracting raw data relating to said information by said processing means,
storing raw data in a memory of said terminal and/or transmitting them to a receiver,
correcting raw data by processing means of said terminal and/or said receiver with the help of contextual data,
transmitting corrected data to the addressee by said terminal or by said receiver.

Advantageously:
this method may comprise the taking of several images and the merging or selection of extracted data, before or after correction,
contextual data and raw data may be transferred to the aforementioned receiver, which may make the aforementioned corrections and transmit the corrected data to the addressee, as requested from the aforementioned terminal,
corrections may be made by the processing means of the terminal while corrected data may be transmitted to the addressee directly by the terminal or indirectly via the receiver,
contextual data may be transmitted to the receiver, which may perform processing of these data and transmit control instructions to the terminal allowing the processing means of the terminal to make corrections to the raw data,
contextual data and raw data relative to said information may be transmitted to the receiver, which may make the aforementioned correction and transmit the corrected data to the addressee as well as control instructions allowing the processing means of the terminal to themselves make the corrections to the raw data,
the aforementioned terminal may comprise means for accessing a bank of images as well as means for carrying out keyed insertion of the corrected data into at least one selected image.

Moreover, the correction step provided in the method according to the invention, may comprise the following operative phases:
producing a contour in the document to be processed or around the document to be processed, either by a manually produced or printed plot (for example, a quadrilateral, a rectangle) or with the help of any recessed material frame,
presenting the document to be processed in front of the camera under any incidence so that the aforementioned contour is entirely visible in the image present on the viewing screen,
contour searching in the image,
computing projective distortions, extracting and merging contents of the images,
generating the final image.

Advantageously, with this method, it is possible to:
facilitate interpretation of the received document by the relevant person,
rebuild the structure of the document from the physical description of the latter,
perform character recognition from software packages known from the state of the art,
transfer the document via a communications network, such as Internet, a cellular network, such as a GSM, GPRS or UMTS network,
store the document on a suitable medium as known from the state of the art,
reduce the size of the digitized information so as to reduce the memory required for its storing and increase the transmission rate of this information.

In this case, the method according to the invention may involve:
a central unit grouping together processing and storage means,
a camera connected to the central unit, preferably attached or integrated to the latter,
a screen for viewing the image taken by a camera,
means for transmitting and storing the digitized information.

The retroconversion of the document, i.e., its conversion to an electronic format, will thereby be made possible, therefore allowing it to be utilized, transmitted and stored.

Embodiments of the invention will be described hereafter, as non-limiting examples, with reference to the appended drawings, wherein:

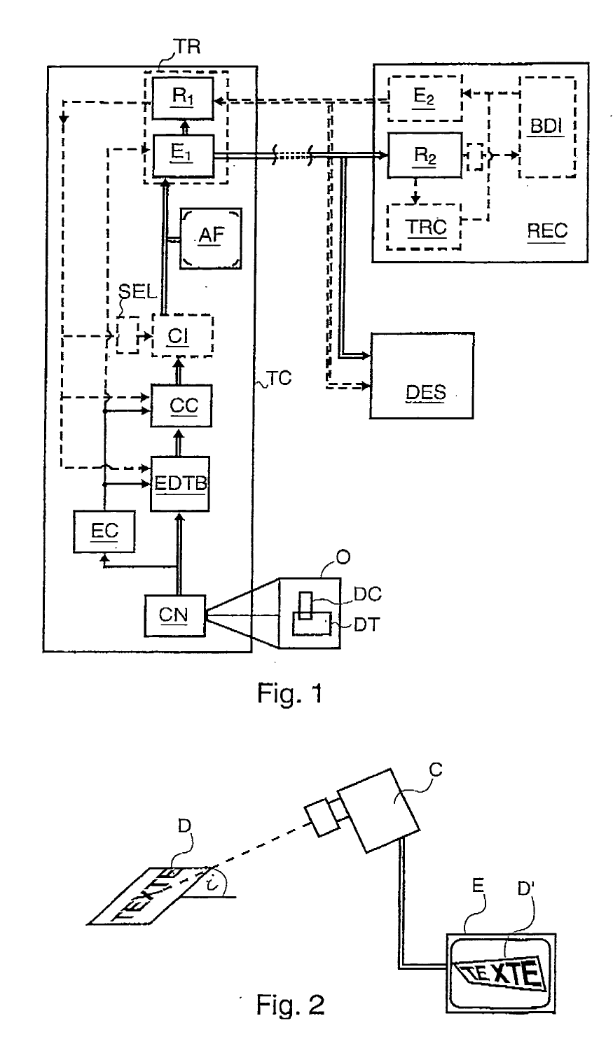

FIG. 1 is a schematic representation of a system for extracting and correcting information contained in an image taken by a communications terminal fitted out with a camera;

FIG. 2 is a schematic representation with which the problems posed by making shots of a document under any incidence may be illustrated;

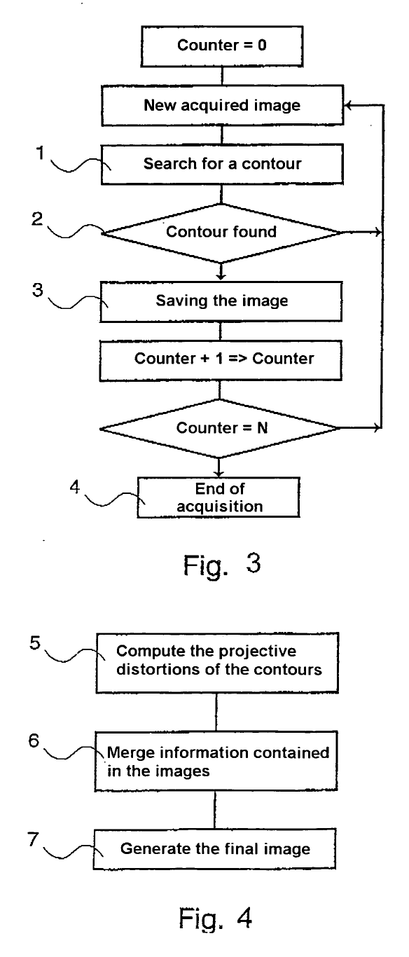

FIG. 3 represents a flow chart relating to the acquisition of the image and to the search for the contour in the image;

FIG. 4 represents a flow chart relating to the extraction, merging of the contents of the images, and generation of the final image;

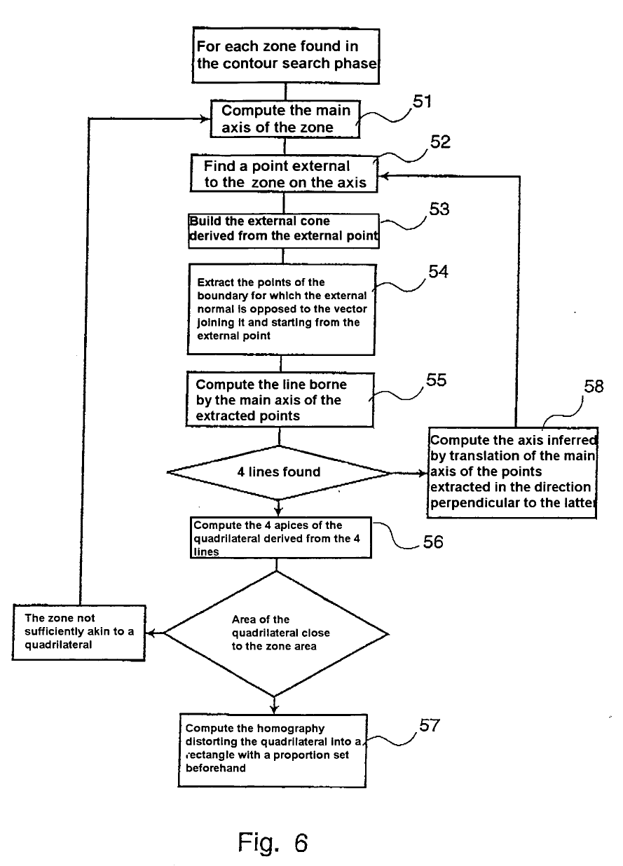

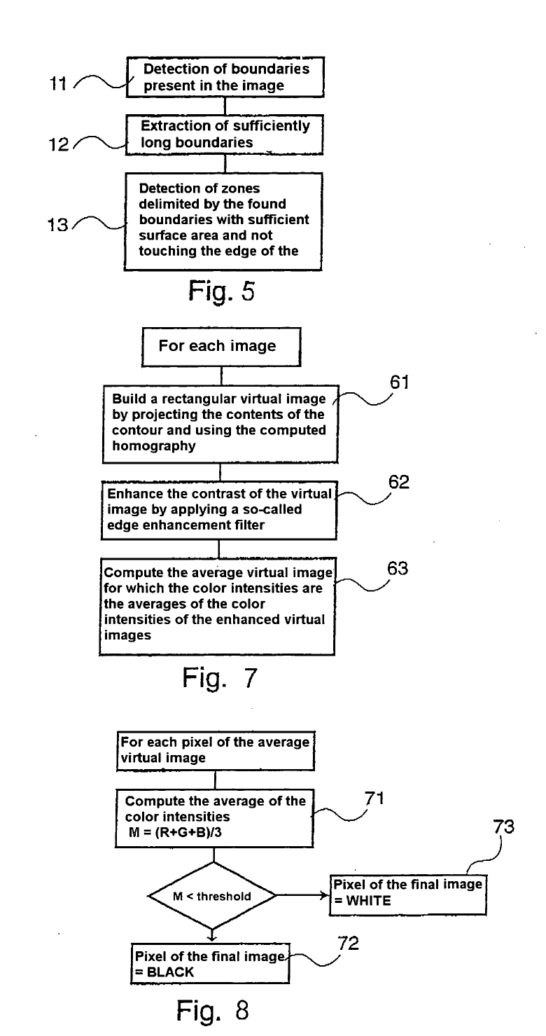

FIG. 5 represents a detailed flow chart relating to the contour search in the image;

FIG. 6 represents a detailed flow chart relating to the selection of the contour and the computation of the projective distortion of the contour found in the image;

FIG. 7 represents a detailed flow chart relating to the merging of information contained in the found contour and the enhancement of contrasts of the images;

FIG. 8 represents a detailed flow chart relating to obtaining the final image;

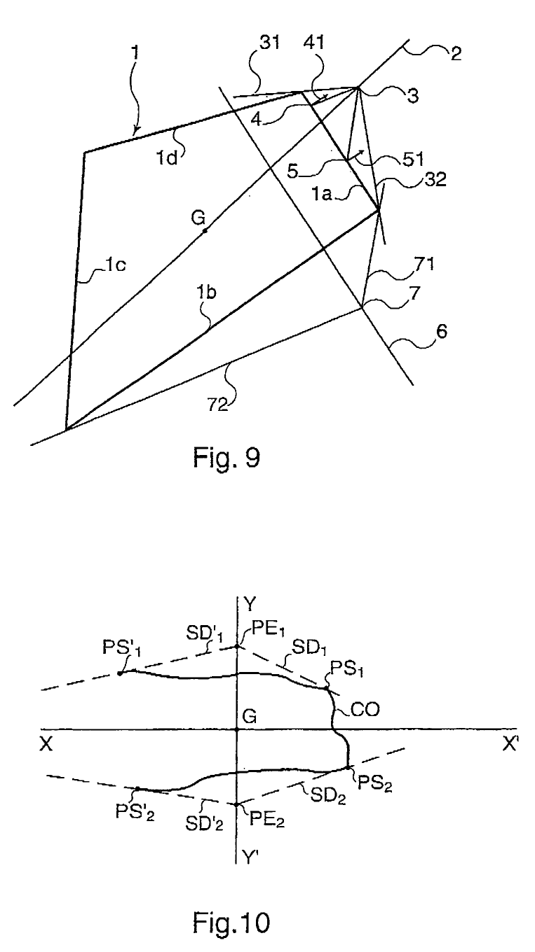

FIG. 9 is a schematic representation illustrating a mode for selecting the contour as a graphic;

FIG. 10 is a schematic representation illustrating another mode for selecting the contour.

In the example represented in FIG. 1, the system for applying the method according to the invention involves a communications terminal TC, including a transmitter TR such as for example, a GSM mobile phone, conventionally comprising an emitter E₁ and a receiver R₁. This TC terminal is fitted out with a digital camera CN for making shots of a medium O comprising textual data DT and contextual data CD.

According to the invention, digital data delivered by the CN camera, for each of the images of medium O, are transmitted to a processing circuit comprising a device for extracting contextual data EC (which may consist of a contour inscribed in medium O, for example, a document which one desires to process) and a device for extracting raw textual data EDTB relative to the information contained in the image. This extraction device EDTB is designed so that it may possibly use the contextual data extracted by the extraction device EC.

The extraction device EDTB is connected to a correcting circuit CC which is designed so as to at least partially correct the raw data delivered by the extraction device EDTB from the contextual data delivered by the extraction device EC.

The data corrected by the correcting circuit CC are transmitted to the emitter E₁ of transmitter TR in order to be retransmitted to an addressee DES, either directly, or via the receiving device REC located at a distance from transmitter TR.

The receiving device REC is equipped with a processing circuit TRC for correcting raw data, possibly partly corrected by the correcting circuit CC of the communication terminal TC. This correction is made with the help of contextual data extracted by the extraction device EC and transmitted to the receiving device REC by terminal TC. Also, this receiving device REC may be fitted out with a system for automatic writing recognition in order to be able to reuse the information in a text editor.

Alternatively, the receiving device REC may be designed in order to develop processing instructions or algorithms from the contextual data transmitted by terminal TC and for transmitting these instructions or these algorithms to the correcting circuit CC, via an emitter E₂ and receiver R₁, so as to allow the TC terminal to make the corrections to the raw data by means of the simplified correcting circuit CC (unwieldy processing operations which require significant resources being performed by the processing circuit TRC of the receiving device REC).

The data corrected by the correcting circuit CC or by the TRC processing circuit, may be transmitted to a keyed insertion circuit CI located upstream from the transmitter TR which enables these corrected data to be included or possibly merged into at least an image selected by the SEL selection circuit. Conversely, the keyed insertion circuit may comprise means for incorporating into said selected image, other pieces of information such as for example textual and/or graphic information.

This image may for example consist of a monochrome background. It may be selected from a plurality of images stored or possibly downloaded in terminal TC, or even from those taken by the camera.

Advantageously, these images may be derived from an image data bank BDI fitting out receiver REC.

In this case, the TC terminal may be designed so as to send to the REC receiver, a command for selecting an image contained in the BDI data bank.

Also, the REC receiver will be designed in order to send to the TC terminal, the selected image for performing the keyed insertion.

Of course, terminal TC may comprise a display AF for viewing the data and possibly the contextual data, possibly inserted in an image, before their being transmitted to the DES addressee, either directly, or via the REC receiver.

In the example illustrated in FIG. 2, camera C is centered on the center of a rectangular document D according to an incidence angle i. The image of this document, captured by camera C as viewed on screen E, has undergone a projective distortion and therefore has a trapezoidal shape D′.

To abolish this drawback, the invention proposes prior inclusion of contextual data into the document D, here a closed contour in the document to be processed or around the document to be processed. This contour may also consist of the peripheral edge of the document; it thereby forms a digitization zone viewed by the camera; the successive images acquired by the camera are made visible on the viewing screen.

According to the flow chart of FIG. 3, for each of the shots requested by the user, the method comprises a first search step for the contour (block 1), until the found contour is obtained (block 2); the contour having been detected, the image is saved (block 3) and acquisition is completed; the process is repeated until N images are obtained, N being set beforehand (block 4).

According to the flow chart of FIG. 4, from saved images, the method performs a computation of the projective distortions of the contours (block 5), and then the merging of the information contained in the images (block 6) and finally the generation of the final image (block 7).

According to the flow chart of FIG. 5, the method comprises the detection of boundaries present in the image (block 11), the extraction of sufficiently long boundaries (block 12) and the detection of zones delimited by the found boundaries with sufficient surface area and not touching the edge of the image (block 13).

According to the flow chart of FIG. 6, the method proposes for each zone found in the contour search phase, computing the main axis of the zone (block 51), then finding an external point to the zone on the axis (block 52), then building the external cone from the external point (block 53), then extracting the points from the boundary, the external normal of which is opposed to the vector which joins it and starts from the external point (block 54), then computing the line borne by the main axis of the extracted points (block 55), and then after finding four lines, computing the four apices of the quadrilateral from the four lines (block 56), and then, as the quadrilateral surface area is close to the surface area of the zone, computing the homography distorting the quadrilateral into a rectangle with a proportion set beforehand (block 57).

If four lines are not found, the method proposes computing the axis inferred by translation of the main axis of the extracted points, in the direction perpendicular to the latter (block 58).

If the surface area of the rectangular quadrilateral is not close to the surface area of the yet unconsidered zone, the method proposes again performing a computation of the main axis of the zone (block 51), followed by the operations as defined above.

According to the flow chart of FIG. 7, the method for each image to be processed by correcting the projective distortion, comprises the building of a rectangular virtual image by projecting the contents of the contour by using the computed homography (block 61), the enhancement of the contrast of the virtual image by applying a so-called edge enhancement filter (block 62), and then computing the average virtual image for which the color intensities are the averages of the color intensities of the enhanced virtual images (block 63).

According to the flow chart of FIG. 8, the method proposes for each pixel of the average virtual image, computing the average of the color. intensities, according to the formula M=(R+G+B)/3 (block 71). If the term M is less than a predetermined threshold, the pixel of the final image is considered to be black (block 72); on the contrary, if the term M is larger than this same threshold, the pixel of the final image is considered to be white (block 73).

The sought-after contour 1 is illustrated in FIG. 9, by four line segments 1a, 1b, 1c, and 1d;
i.e. line 2, the main axis of the zone delimited by contour 1, passing through the center of gravity G,
i.e. point 3, located outside the zone on axis 2,
i.e. half-lines 31 and 32, from point 3, forming the cone external to the line segment 1a of contour 1,
i.e. points 4 and 5, located on segment 1a,
i.e. the external normals to contour 41 and 51, the half-lines perpendicular to the line segment 1a, at points 4 and 5.

Points 4 and 5 are two points among the extracted points which define the boundary of the zone materialized by the line segment 1a, as the normals external to contours 41 and 51 are opposed to half-lines joining points 3 and 4, 3 and 5, respectively.

The search for other line segments 1b, 1c, and 1d, is performed according to the same method from line 6, inferred by translation of the line segment 1a, by moving away from the latter relatively to point 3, and from point 7, located on line 6, outside the zone delimited by contour 1, and half-lines 71 and 72 forming the cone external to the line segment 1b.

In this example, the method for selecting a camera digitizing zone for correcting the projective distortion, for enhancing the resolution, then for binarization comprises:
achieving a closed contour in the document to be processed or around the document to be processed, either by a manually produced or printed plot (for example, a quadrilateral, a rectangle), or with the help of any recessed material frame,
presenting the document to be processed in front of the camera under any incidence so that the aforementioned contour and the aforementioned document are entirely visible in the image present on the viewing screen,
detecting boundaries present in the image,
extracting sufficiently long boundaries,
detecting zones delimited by the found boundaries with a sufficient surface area and not touching the edge of the image,
searching for new boundaries and proceeding with the process if the contour is not found, until obtaining a contour allowing the image to be saved and acquired,
saving and acquiring the image if a contour is found,
computing the projective distortions of the contours consisting of computing the main axis of the zone, then finding a point external to the zone on the axis, then building the external cone from the external point, then extracting the point of the boundary for which the external normal is opposed to the vector which joins it and starts from the external point, then computing the line borne by the main axis of the extracted point, and then, four lines having been found, computing the four apices of the quadrilateral derived from the four lines, then as the surface area of the rectangular quadrilateral is close to the surface area of the yet unconsidered zone, computing the homography distorting the quadrilateral into a rectangle with a proportion set beforehand,
computing the axis inferred by translation of the main axis of the extracted point, in the direction perpendicular to the latter, if the four lines are not found,
again computing the main axis of a yet unconsidered zone, followed by the previous operation, if the surface area of the rectangular quadrilateral is not close to the surface area of the zone,
building for each image a rectangular virtual image by projecting the contents of the contour by using the computed homography,
enhancing the contrast of the virtual image by applying a so-called edge enhancement filter, computing the average virtual image for which color intensities are the averages of color intensities of the enhanced virtual images,
computing the average virtual image for which color intensities are the averages of color intensities of the enhanced virtual images,
computing, for each pixel of the average virtual image, the average M of the color intensities,
designating as black pixel, any pixel for which the term M is less than a predetermined threshold,
designating as white pixel, any pixel for which the term M is larger than a predetermined threshold.

Hence, this method provides presentation, utilization, transmission and storage of texts and digitized graphics, previewed by a camera under any incidence, then processed by correcting the projective distortion and enhancing the resolution.

Of course, the invention is not limited to the above described embodiment.

Thus, notably, the contextual data may comprise an unclosed contour drawn by hand. In this case, detection of this contour CO may be carried out according to an operating sequence comprising the following steps (FIG. 10):
searching along an horizontal line, for example the center line of the image of a pixel having with the surrounding pixel(s), for a significant change in of level (for example, as determined by the first derivative of the grey levels of the image at these pixels),
if no pixel is found in the previous step on the horizontal line, similar searching along at least one vertical line (for example, the center line),
tracking the assumed curve formed by the pixels with significant level variation, by iteratively testing the still unexplored neighboring pixels,
computing the center of gravity G and the main axes XX′-YY′ of the previously determined contour,
testing for determining whether the points of the contour have a reasonable dispersion ratio between both main directions,
selecting an axis of the contour (this axis will preferably be a main axis XX′-YY′ of the contour, and if necessary, a secondary axis) and, on this axis:
determination on either side of the contour CO of the external points PE₁ and PE₂ located outside the contour CO at a distance of a few pixels and, for each external point,
determination of both pairs of singular points (PS₁, PS′₁)-(PS₂, PS′₂) such as for example, angles or ends of the contour, by using for this purpose, for each of the external points PE₁, PE₂, two line segments (SD₁, SD′₁)-(SD₂, SD′₂) from an external point and defining an angle in which the contour is inscribed, and
computing the projective transformation parameters by using the geometrical shape defined by the singular points (PS₁, PS′₁)-(PS₂, PS′₂).

In the example of FIG. 10, the contour CO approximately has the shape of a laid down U. In this case, the singular points consist of both ends PS′₁, PS′₂ of the contour CO and of both apices PS₁, PS₂ of the angles formed between the core and both legs of the U. The main axis XX′ is not used because it only intersects the contour once. This is why the YY′ axis is used (which again intersects the main axis XX′ at the center of gravity G).

Moreover, the method according to the invention may comprise a process for classifying the medium of the image (plain paper/square-ruled paper) and for removing the squaring in the case of square-ruled paper.

This process consists of determining whether the plots of the low gradient (grey level variation) image form squaring extending to at least a boundary of the image. If this is the case, the method consists of raising the threshold beyond which the gradients are taken into account in order to remove the squaring. Of course, this process implies that the squaring lines have a lower contrast (with reference to the paper) than the hand-written contents of the image, which is true in the very large majority of the cases.

This process may comprise the following steps:
selecting the smallest significant gradient threshold as regards noise for detecting the contour for example in the way indicated above,
if the detected patterns touch a boundary surrounding the image, inferring that the squaring lines are present on the medium,
if squaring lines are present, incrementing the gradient threshold and then again performing the second step with the new threshold, this process being repeated until the found contour no longer touches the edge,
using the last gradient threshold (the gradient for having the squaring
lines disappear) in order to extract the data contained in the image (for example according to a standard extraction process) without taking the squaring lines into consideration.

Also, the process for extracting data may be carried out according to a sequence comprising the following steps:
a) determining, for each point of the image, a value V₀[C,L] consisting in a combination of color components of the image for the point located by column C and line L of the image, this value V₀[C,L] being expressed as:
   V₀[C,L]=αRed[C,L]+βGreen[C,L]+γBlue[C,L]

A formula wherein α, β, γ are coefficients which may for example satisfy the following relationships:
α+β+γ=1 and α,β,γ≧0
b) computing, for each point of the image, a value V_{N+1} [C,L] in the following way (according to whether this is dark information on a bright background or vice versa):

$${V}_{N + I} [ C , L ] = ( {or min}^{max} ) \{ {V}_{N} [ C , L ] \frac{{V}_{N} [ C + 1 , L + 1 ] + {V}_{N} [ C - 1 , L - 1 ]}{2} \frac{{V}_{N} [ C + 1 , L - 1 ] + {V}_{N} [ C - 1 , L + 1 ]}{2} \frac{{V}_{N} [ C , L + 1 ] + {V}_{N} [ C , L - 1 ]}{2} \frac{{V}_{N} [ C + 1 , L ] + {V}_{N} [ C - 1 , L ]}{2} \}$$
c) iterating step b, a predetermined number of times, then taking the final value V_{Nfinal} into account
d) computing the difference D[C,L] for each point of the image
   D[C,L]=V_{Nfinal}[C,L]−V₀[C,L] (or V₀[C,L]−V_{Nfinal}[C,L])
e) comparing for each point of the image, the value D[C,L] with a threshold value V_{S} so as to determine the values to be extracted, in the following way:
   if D[C,L]<V_{S}, then D[C,L]=0
   if D[C,L]≧V_{S}, the value D[C,L] is retained or replaced with D[C,L]−V_{S}
f) the values of D[C,L] are quantified in a predetermined number of levels (it being understood that binarization is achieved if the number of levels is equal to 2).

The threshold value (V_{S}) may possibly consist of the gradient threshold value for disappearance of the squaring, used in the squaring removal process described above.

1. A method for digital capture of information present on a medium by a camera fitting out a communications terminal, as well as for storing and/or transmitting through this terminal, to an addressee, said information, said method comprising the following steps:
taking at least one image of the medium with the camera,
at least partially extracting identifiable contextual data included in said image by processing means integrated to said terminal,
extracting raw data relative to said information by said processing means with the help of contextual data,
storing in a memory of said terminal and/or transmitting towards a receiver, the extracted information,
correcting the raw data by processing means of said terminal and/or of said receiver with the help of contextual data,
transmitting the corrected data to the addressee by said terminal or by said receiver.

2. The method according to claim 1, which comprises the taking of several images and the merging or selection of the aforementioned data before or after correction.

3. The method according to claim 1, wherein said contextual data and said raw data are transmitted to said receiver, which makes said corrections and transmits the corrected data to the addressee as requested from said terminal.

4. The method according to claim 1, wherein said correction is made by processing means of the terminal, and in that the corrected data are directly transmitted to the addressee by the terminal or indirectly via the receiver.

5. The method according to claim 1, wherein the contextual data are transmitted to the receiver, which performs processing of the data and transmits control instructions to the terminal enabling the processing means of the terminal to make the corrections to the raw data.

6. The method according to claim 1, wherein the contextual data and the raw data relative to said information are transmitted to the receiver, which makes the aforementioned corrections or transmits the corrected and/or interpreted data to the addressee as well as possibly the control instructions enabling the processing means of the terminal to make the corrections to the raw data.

7. The method according to claim 1, wherein said terminal comprises means for carrying out the keyed insertion and/or the merging of corrected data into at least a selected image which may consist of a monochrome background.

8. The method according to claim 7, wherein said image is selected in a bank of images or is taken by the camera of the terminal.

9. The method according to claim 8, wherein the bank of images is directly accessible by the terminal or indirectly via the receiver.

10. The method according to claim 1, wherein the corrections made in the correcting step deal with geometry, contrast and/or color.

11. The method according to claim 1, wherein the corrected data are transmitted to the receiver and/or to the addressee in vector form.

12. The method according to claim 1, wherein the said terminal comprises means for rebuilding the colors contained in the image and/or the background and/or for selecting the colors which may be used in the correction process.

13. The method according to claim 1, wherein the said contextual data are materialized by a closed or open contour, possibly plotted by hand on the medium, and wherein the step for extracting contextual data comprises the search for the contour in the image and the computation of the projective distortions of the contour.

14. The method according to claim 13, wherein the search for the contour in the image comprises:
detecting boundaries present in the image (block 11),
extracting sufficiently long boundaries (block 12),
detecting zones delimited by the found boundaries with sufficient surface area and not touching the edge of the image (block 13),
searching for new boundaries and proceeding with the process if the contour is not found, until a contour is obtained.

15. The method according to claim 13, comprising a step of extracting one image and of generating a final image, said extracting and generating step comprising:
computing the projective distortions of the contours consisting of computing the main axis of the zone (block 51), then finding an external point to the zone on the axis (block 52), then building the external cone from the external point (block 53), then extracting the points of the boundary for which the external normal is opposed to the vector which joins it and starts from the external point (block 54), then computing the line borne by the main axis of the extracted points (block 55), then, four lines having been found, computing the four apices of the quadrilateral derived from the four lines (block 56), then, as the surface area of the rectangular quadrilateral is close to the surface area of the yet unconsidered zone, computing the homography distorting the quadrilateral into a rectangle with a proportion set beforehand (block 57),
computing the axis inferred by translation of the main axis of the extracted points, in the direction perpendicular to the latter, if four lines are not found,
again computing the main axis of a yet unconsidered zone (block 58), followed by the previous operations, if the surface area of the rectangular quadrilateral is not close to the surface area of the zone,
building for each image, a rectangular virtual image by projecting the contents of the contour by using the computed homography (block 61), and
possibly enhancing the contrast of the virtual image by applying a so-called edge enhancement filter (block 62).

16. The method according to claim 15, which comprises a binarization phase including the following steps:
computing the average virtual image for which the color intensities are the averages of the color intensities of the enhanced virtual images (block 63),
computing, for each pixel of the average virtual image, the average M of the color intensities (block 71),
designating as a black pixel, any pixel for which the term M is less than a predetermined threshold (block 72),
designating as a white pixel, any pixel for which the term M is larger than a predetermined threshold (block 73).

17. The method according to claim 1, wherein the contextual data are materialized by a closed or unclosed contour included in the image and in that detection of this contour in order to extract contextual data is performed according to the following sequence:
searching along a first line of a pixel having a significant change in level with the surrounding pixels,
searching along another line if no pixel was found in the previous step,
tracking the assumed curve by the pixels with significant change in level, by iteratively testing the yet unexplored neighboring pixels,
computing the center of gravity and the main axes of the previously determined contour,
selecting an axis of the contour and on this axis:
determining, on either side of the contour external points (PE₁, PE₁) located outside the contour, at a distance of a few pixels, and for each external point,
determining two pairs of singular points (PS₁, PS′₁-PS₂, PS′₂), by using for this purpose, for each of the external points (PE₁, PS₂), two line segments (SD₁, SD′₁-SD₂, SD′₂) derived from an external point and defining an angle in which the contour is inscribed, and
computing the projective transformation parameters by using the geometrical shape defined by the singular points (PS₁, PS′₁)-PS₂, PS′₂).

18. The method according to claim 1, which comprises the classifying of the medium of the image and removal of squaring possibly present on the medium, this classification including the following steps:
selecting the smallest significant gradient threshold as regards noise, for detecting the contour, for example in the way indicated above,
if the detected patterns touch a boundary surrounding the image, inferring that squaring lines are present on the medium,
if squaring lines are present, incrementing the gradient threshold, then again performing the second step with the new threshold, this process being repeated until the found contour no longer touches the edge,
using the last gradient threshold (gradient for disappearance of the squaring lines) for extracting the data contained in the image.

19. The method according to claim 1, wherein the extraction of the aforementioned data comprises the following operating phases:
a) determining, for each point of the image, a value V₀[C,L] by combining color components of the image for the point located at the intersection of a column and of a line of the image,
b) computing for each point of the image, a value V_{N+1}[C,L] by selecting the maximum or minimum value between V_{N}[C,L] and the average values of the pairs of opposite points with respect to the one located at the intersection of column and of line,
c) iterating step b, a predetermined number of times, then taking a final value (V_{Nfinal}) into account,
d) computing, for each point of the image, the difference
D[C,L]
D[C,L]=V_{Nfinal}[C,L]−V₀[C,L] (or V₀[C,L]−V_{Nfinal}[C,L])
value to be extracted, and quantifying the extracted values in a predetermined number of levels.

20. The method according to claim 18, wherein the threshold value, consists of the gradient threshold value for disappearance of the squaring.

21. The method according to claim 19, wherein the threshold value, consists of the gradient threshold value for disappearance of the squaring.
